(19) United States
(12) Patent Application Publication
(10) Pub. No.: US 2008/0271682 A1
(43) Pub. Date: Nov. 6, 2008

(54) Methodology and design of an interactive pet toy that inspires play behavior in cats

(76) Inventor: Cherie Lynn Sauer, Port Charlotte, FL (US)

Correspondence Address: Cherie Lynn Sauer, 5164 Crawfordsville Drive, Port Charlotte, FL, 33948, US

(21) Appl. No.: 11/799,086

(22) Filed: May 1, 2007

(51) Int. Cl. A01K 29/00

(52) U.S. Cl. 119/707

(57) ABSTRACT

The methodology and design of an interactive pet toy that inspires play behavior in cats by incorporating four stimulation or “play-inspiring” factors and consists of a set of equal length cords, in certain materials and widths; of lengths and corresponding weights that create identified movements; in colors included in the visual spectrum of the cat; with other attributes appealing to cats; attached to a handle designed for human comfort; and with decorative pieces for aesthetic purposes.

### CROSS-REFERENCE TO RELATED APPLICATIONS

There are many toys in the marketplace that have been developed to entertain cats. Some of these toys are in the patent database and apply to this Invention—that is, of a type that includes a handle and “tail-like” or “string-like” appendages. U.S. Design Pat. Nos. 5,924,387 (Schramer), D309,964 (Viner et al.), D452,050 (Ritchey), 4,712,510 (Tae-Ho), and D431,331 (Smith) include cat toys with a general reference to a handle (expandable or otherwise) with some type of toy-like item or substance attached to the end. U.S. Pat. No. 5,755,184 (Neidenberger), references brightly colored silicone rubber attached to a wire handle—this also is an interactive toy requiring human involvement.

All of these toys are effective in some degree to stimulate cat attack and play behavior. However, 1) not one of these toys addresses all four of the unique stimulation factors used in the submitted Invention; 2) none of these are constructed in the same materials of the Invention; 3) none are constructed in the same size, shape, number of appendages, color specifications, and scientific movement patterns of the Invention; and 4) the majority of these toys include some type of attachment on the end—whether utilitarian or decorative—which could be considered the main purpose of the toy and/or a safety risk. The Invention does not include extra end attachments.

### STATEMENT REGARDING FEDERALLY SPONSORED RESEARCH OR DEVELOPMENT

N/A

### REFERENCE TO SEQUENCE LISTING, A TABLE, OR A COMPUTER PROGRAM LISTING COMPACT DISC APPENDIX

N/A

### BACKGROUND OF THE INVENTION

The field of Invention relates to pet toys in general and interactive cat toys in particular.

The increase in domestic pet adoption combined with recent research related to companion animal care has generated a domestic population of indoor pets with limited or no access to outdoor activities. Although this trend is in the interest of animal safety, it has created a particular problem for cats which need mental and physical stimulation for healthy weight maintenance and mental health balance. Cats are particularly susceptible to behavioral and physical problems related to boredom and loneliness.

Many toys have been invented to entertain cats, some of them interactive and some indicated for self-play. The majority of these toys exhibit the use of two or less stimulation factors* in the design of the units. This is an inadequate number to sustain play in cats as they often disengage from existing single or two-dimensional stimulation toys because the excitement level drops with skill-level. These toys are quickly mastered and the cat looks elsewhere for entertainment. Interactive toys are the most interesting to cats because the human's movements are unpredictable and become part of the stimulation. * Note: Some toys on the market use or recommend the use of catnip or other natural “drug-like” substances in their toys and although we do consider these natural substances to be valid stimulation factors, the Patent office has a separate designation for these toys and none are used in the Invention. Therefore, we are not considering use of these substances to be valid for our comparisons.

Of the interactive toys, we are most concerned with those with string-like appendages. Cats enjoy these because the generated movements can be quick like prey and challenging to catch. However, a cat's interest in interactive string toys can wan quickly—especially with single appendage toys—requiring the human partner to devote more energy into making the game interesting. Some appendage toys can also constitute a health hazard if the string or attachment can be bitten off and swallowed.

Cats disengage even more swiftly from appendage toys that are overly complicated. In cases where there are too many appendages for example, the cat may cautiously retreat in fear rather than engage with excitement. They may also become confused from being subjected to too many, unidentified, possibly threatening parts. This aversion to multi-functional, multi-textured, moving parts could be attributed to a new theory into animal behavior which suggests that animals see the world much in the same as autistic children—with deep focus and concentration on small details rather than with “big picture” views (Reference: Animals in Translation: Using the Mysteries of Autism to Decode Animal Behavior, Temple Grandin, 2006).

It becomes clear when reviewing the existing cat toy market that a toy is needed that not only relieves boredom by being sufficiently challenging without being distracting or overly complex, but that also relieves periods of loneliness in cats by requiring human interaction. The Invention addresses this need in a unique fashion incorporating four stimulation factors.

### BRIEF SUMMARY OF THE INVENTION

The Invention addresses the existing weaknesses of other cat toys on the market by incorporating four stimulation factors (which we refer to as “play-inspiring factors”) into one human/animal interactive toy as follows: a) includes a limited, but challenging number of moving parts—specifically two or three appendages of certain lengths; b) inspires prey-hunting and play behavior due to the resonant frequency, wavelength, and other movements generated through human manipulation of the product; c) requires an advanced level of mental acuity/concentration to visualize, attack, and capture the appendages; and d) uses specific colors and composition materials that inspire play in cats, specifically flat cords of a specified width in colors in the cat's visual spectrum. In addition, the durability of the cords prevents cats from biting them into pieces and the lack of an end piece removes the small part safety danger. As such, this Invention is not only significantly different than other toys on the market, but also uses superior methodology and design for safely inducing play behavior in cats.

The patentable system and Invention specifics are detailed in the claims section but are summarized as follows: the methodology and design of an interactive pet toy that inspires play behavior in cats by incorporating four stimulation or “play-inspiring” factors; consisting of a set of equal length cords, the number of which provides challenge without overloading the cat's sensory system; such cords to be in certain widths and materials which are appealing to cats because the fabricated nature of the cords requires mental acuity and concentration for capture; in a certain length and corresponding weight that creates identified movements considered to appeal to a cat's prey-hunting instincts; in colors included in the visual spectrum of the cat; with other attributes appealing to cats; attached to a handle designed for human comfort; and with decorative pieces for aesthetic purposes.

### BRIEF DESCRIPTION OF THE SEVERAL VIEWS OF THE DRAWING

FIG. 1: Depicts the Invention in a two cord, crosswise handle version showing the final constructed product view and detailing the approximate location of knots, length of cord, and placement of crosswise handle.

FIG. 2: Depicts the Invention in a three cord, grip handle version showing the final constructed product view and detailing the approximate location of knots, length of cord, and placement of grip handle, as well as possible aesthetic decoration placement.

FIG. 3: Depicts an approximation of the serpentine-like resonant frequency and wavelength generated by using waving motions with the Invention.

### DETAILED DESCRIPTION OF THE INVENTION

The methodology and design of an interactive pet toy that inspires play behavior in cats by incorporating four stimulation or “play-inspiring” factors and consists of a set of equal length cords, in certain materials and widths; of lengths and corresponding weights that create identified movements; in colors included in the visual spectrum of the cat; with other attributes appealing to cats; attached to a handle designed for human comfort; and with decorative pieces for aesthetic purposes.

The four stimulation or play-inspiring factors are described as follows: a) includes a limited, but challenging number of moving parts; b) inspires prey-hunting and play behavior due to the resonant frequency, wavelength, and other movements generated through human manipulation of the product; c) requires an advanced level of mental acuity/concentration to visualize, attack, and capture the appendages; and d) uses specific colors and composition materials that inspire play in cats.

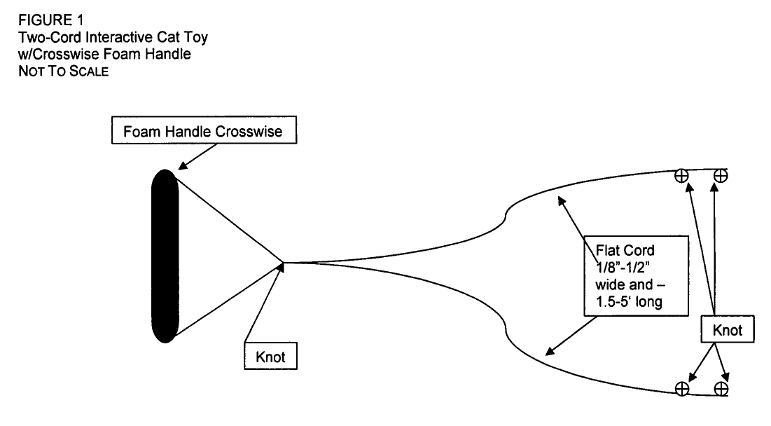

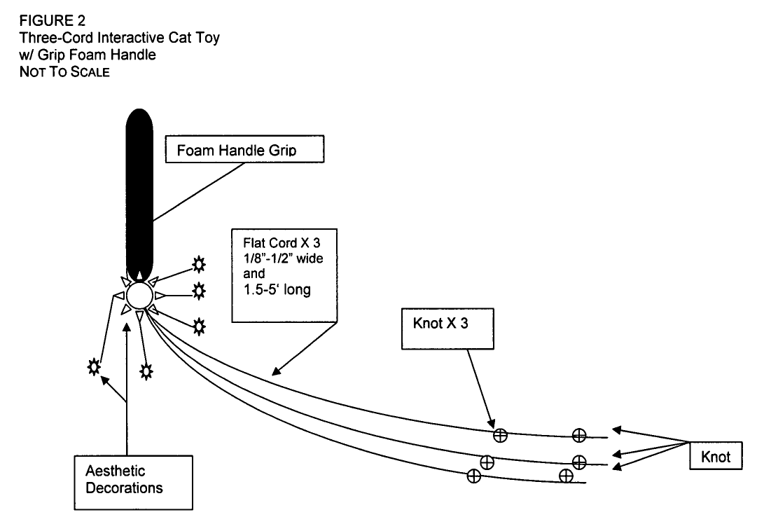

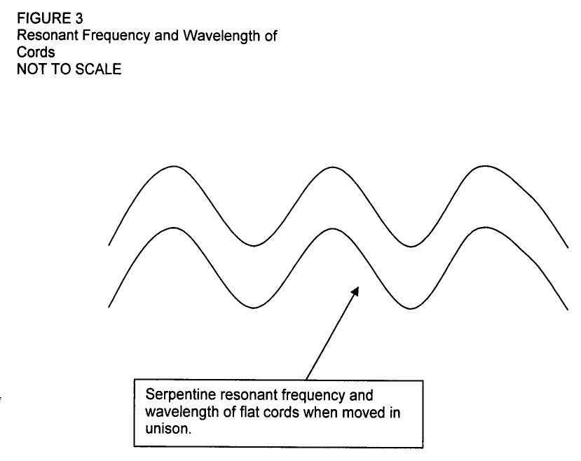

The preferred embodiment includes a flat cord material in a width from ⅛″ to ½″; made of nylon or nylon composites; cut into a length where the end result delivers exactly 2 or 3 hanging cords in identical lengths, each of which has between 1.5 and 5 feet of length exposed and together create a certain specific resonant frequency and corresponding wavelength when waved back and forth—such frequency to be considered serpentine in nature (FIG. 3)—and also separate, independent prey-like movements in each cord when whipped or otherwise moved; in colors within the visual spectrum of a cat, including most specifically, green, blue, and purple; with a series of knots in the cord that allow less skilled or declawed animals a purchase on the cord; attached to a fabricated foam handle designed to be held in comfort by the human participant either a) in crosswise fashion much like the handle held in waterskiing with the cords knotted at a specific distance below the handle that creates weight balance in the toy and leaves openings that are large enough for a cat to easily remove its head (FIG. 1) or b) designed to be held in grip-like fashion much like the handle of a whip (FIG. 2); and with decorative pieces added for human aesthetic appreciation including, at times, may ornamental strings that are less than 1.5′ in length (FIG. 2).

The invention can be constructed as follows: the flat cord material shall be cut into a length where the end result delivers exactly 2 or 3 hanging cords in identical lengths, each of which has between 1.5 and 5 feet of exposed length. The cord(s) shall be attached to a fabricated foam handle either by first attaching the cord to a dowel and inserting it into the handle, or by some other usable method. In the case of the crosswise handle, the cords shall be tied together at a distance below the foam handle that creates balance and with openings large enough for a cat to easily remove its head; Individual knots shall then be tied in the bottom of the cords at distances suitable to inspire a cat's interest and to allow for capture. Decorative pieces may be added as desired for human appreciation.

I claim:

1. The Methodology and Design of An Interactive Pet Toy That Inspires Play Behavior in Cats by incorporating four stimulation or “play-inspiring” factors:
consisting of a set of equal length cords, the number of which provides challenge without overloading the cat's sensory system;
such cords to be in certain widths and materials which are appealing to cats because the fabricated nature of the cords requires mental acuity and concentration for capture;
in a certain length and corresponding weight that creates identified movements considered to appeal to a cat's prey-hunting instincts;
in colors included in the visual spectrum of the cat;
with other attributes appealing to cats;
attached to a handle designed for human comfort;
and with decorative pieces for aesthetic purposes.

2. The toy of claim 1 wherein the four stimulation or play-inspiring factors are described as follows: a) includes a limited, but challenging number of moving parts; b) inspires prey-hunting and play behavior due to the resonant frequency, wavelength, and other movements generated through human manipulation of the product; c) requires an advanced level of mental acuity/concentration to visualize, attack, and capture the appendages; and d) uses specific colors and composition materials that inspire play in cats;

3. The toy of claim 1 wherein the preferred embodiment includes a flat cord material in a width from ⅛″ to ½″.

4. The toy of claim 1 wherein the preferred embodiment includes a flat cord material in a width from ⅛″ to ½″; made of nylon or nylon composites.

5. The toy of claim 1 wherein the preferred embodiment includes a flat cord material in a width from ⅛″ to ½″; made of nylon or nylon composites; cut into a length where the end result delivers exactly 2 or 3 hanging cords in identical lengths, each of which has between 1.5 and 5 feet of length exposed and together create a certain specific resonant frequency and corresponding wavelength when waved back and forth—such frequency to be considered serpentine in nature (FIG. 3)—and also separate, independent prey-like movements in each cord when whipped or otherwise moved.

6. The toy of claim 1 wherein the preferred embodiment includes a flat cord material in a width from ⅛″ to ½″; made of nylon or nylon composites; cut into a length where the end result delivers exactly 2 or 3 hanging cords in identical lengths, each of which has between 1.5 and 5 feet of length exposed and together create a certain specific resonant frequency and corresponding wavelength when waved back and forth—such frequency to be considered serpentine in nature (FIG. 3)—and also separate, independent prey-like movements in each cord when whipped or otherwise moved; in colors within the visual spectrum of a cat, including most specifically, green, blue, and purple.

7. The toy of claim 1 wherein the preferred embodiment includes a flat cord material in a width from ⅛″ to ½″; made of nylon or nylon composites; cut into a length where the end result delivers exactly 2 or 3 hanging cords in identical lengths, each of which has between 1.5 and 5 feet of length exposed and together create a certain specific resonant frequency and corresponding wavelength when waved back and forth—such frequency to be considered serpentine in nature (FIG. 3)—and also separate, independent prey-like movements in each cord when whipped or otherwise moved; in colors within the visual spectrum of a cat, including most specifically, green, blue, and purple; with a series of knots in the cord that allow less skilled or declawed animals a purchase on the cord.

8. The toy of claim 1 wherein the preferred embodiment includes a flat cord material in a width from ⅛″ to ½″; made of nylon or nylon composites; cut into a length where the end result delivers exactly 2 or 3 hanging cords in identical lengths, each of which has between 1.5 and 5 feet of length exposed and together create a certain specific resonant frequency and corresponding wavelength when waved back and forth—such frequency to be considered serpentine in nature (FIG. 3)—and also separate, independent prey-like movements in each cord when whipped or otherwise moved; in colors within the visual spectrum of a cat, including most specifically, green, blue, and purple; with a series of knots in the cord that allow less skilled or declawed animals a purchase on the cord; attached to a handle designed to be held in comfort by the human participant either a) in crosswise fashion much like the handle held in waterskiing with the cords knotted at a specific distance below the handle that creates weight balance in the toy and leaves openings that are large enough for a cat to easily remove its head (FIG. 1), or b) designed to be held in grip-like fashion much like the handle of a whip (FIG. 2).

9. The toy of claim 1 wherein the preferred embodiment includes a flat cord material in a width from ⅛″ to ½″; made of nylon or nylon composites; cut into a length where the end result delivers exactly 2 or 3 hanging cords in identical lengths, each of which has between 1.5 and 5 feet of length exposed and together create a certain specific resonant frequency and corresponding wavelength when waved back and forth—such frequency to be considered serpentine in nature (FIG. 3)—and also separate, independent prey-like movements in each cord when whipped or otherwise moved; in colors within the visual spectrum of a cat, including most specifically, green, blue, and purple; with a series of knots in the cord that allow less skilled or declawed animals a purchase on the cord; attached to a handle designed to be held in comfort by the human participant either a) in crosswise fashion much like the handle held in waterskiing with the cords knotted at a specific distance below the handle that creates weight balance in the toy and leaves openings that are large enough for a cat to easily remove its head (FIG. 1) or b) designed to be held in grip-like fashion much like the handle of a whip (FIG. 2); and with decorative pieces added for human aesthetic appreciation including, at times, may ornamental strings that are less than 1.5′ in length.

10. The toy of claim 8 where in the preferred embodiment, the handle is of fabricated foam constructed by attaching the flat cords to a dowel and inserting them into the foam handle, or by some other means.
